(19) United States
(12) Patent Application Publication
(10) Pub. No.: US 2006/0194490 A1
(43) Pub. Date: Aug. 31, 2006

(54) Temporary changes in the properties of papermachine clothing

(75) Inventors: Mark Hodson, Lancashire (GB); Torben Schlieckau, Heidenheim (DE); Arved Westerkamp, Dettingen/Ems (DE); Berry Brockoetter, WG Neede (NL)

Correspondence Address: GREENBLUM & BERNSTEIN, P.L.C., 1950 ROLAND CLARKE PLACE, RESTON, VA, 20191, US

(73) Assignee: Voith Paper Patent GmbH, Heidenheim (DE)

(21) Appl. No.: 11/258,129

(22) Filed: Oct. 26, 2005

(30) Foreign Application Priority Data
Oct. 27, 2004 (DE) 10 2004 052 234.0

(51) Int. Cl. B32B 5/02

(52) U.S. Cl. 442/85

(57) ABSTRACT

Method for changing properties of papermachine clothing, in particular a dryer fabric. The papermachine clothing is processed specifically, primarily in the transverse direction of the clothing, for the purpose of evening out the properties of the fabric. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 10 2004 052 234.0 filed Oct. 27, 2004, the disclosure of which is expressly incorporated by reference herein in its entirety.

### BACKGROUND OF THE INVENTION

1. Field of the Invention

The invention relates to a method for changing properties of a papermachine fabric, in particular a dryer fabric.

2. Discussion of Background Information

U.S. Pat. No. 5,320,299 discloses an apparatus and a method for exerting an adjustable force along the surface in the longitudinal direction of a wound roll of paper. In this apparatus a rider roll system having individual wheel elements is provided, which can in each case be moved rotatably and pivotably toward and away from the roll of paper. The nip force provided by these wheel elements is substantially constant over the entire length of the wound roll of paper but can vary from wheel element to wheel element.

Papermachine clothing, in particular a dryer fabric, normally has the same and uniform properties in the transverse direction of the clothing, that is to say in the direction transverse with respect to the machine running direction. These properties relate, for example, to the contact area, the permeability of the clothing and to the temperature and tension of the papermachine clothing. In practice, for example the problem of an unbalanced moisture profile occurs again and again, above all in the transverse direction of the clothing. For example, it is possible for the case to occur in which, in the transverse direction of the clothing, a uniform moisture content is determined except in a central region of the clothing. There, the moisture content can, for example, be considerably lower or considerably higher than in the edge regions. As a result of such peaks with respect to the moisture content, the running of the paper machine and, ultimately, the quality of the paper produced therewith can be influenced detrimentally.

### SUMMARY OF THE INVENTION

The present invention provides a method of the type specified at the beginning with which problems in the running of the paper machine can be rectified quickly and temporarily. Viewed overall, the intention is for it to be possible for the method to be carried out particularly economically and to impair the running of the paper machine as little as possible.

Accordingly, the invention is directed to a method of the type mentioned at the beginning in which the papermachine clothing is processed specifically, primarily in the transverse direction of the clothing, for the purpose of evening out the properties of the fabric.

In the method according to the invention, the papermachine clothing is processed specifically, primarily in the transverse direction of the clothing, for the purpose of evening out the properties of the clothing. Such processing of the papermachine clothing can be carried out immediately, so that the time until a stoppage of the paper machine which is planned in any case, and therefore of the papermachine clothing, can be bridged without the quality of the paper suffering on account of disadvantageously changed properties of the papermachine clothing. Instead, the specific processing of the papermachine clothing is used to keep the properties of the clothing as uniform as possible in particular but not exclusively in the transverse direction of the clothing, those regions in which the properties of the papermachine clothing has changed considerably in comparison with other regions being processed in particular. This relates in particular to the course of the moisture in the transverse direction of the clothing, preferably what is known as the transverse moisture profile of the clothing. According to the invention, therefore, the regions of the clothing in which the transverse moisture profile exhibits irregularities, such as peaks in the moisture content, are specifically processed. By this specific processing, properties of the papermachine clothing can be rectified, at least for some time, so that irregularities in the aforementioned transverse moisture profile can be corrected and balanced out. The method according to the invention is suitable in particular for bridging the time until a planned stoppage of the paper machine, in which the actual reason for the change in the relevant property of the papermachine clothing can then be determined and rectification of the damage can, so to speak, be carried out at the source. With the aid of the method according to the invention, therefore, properties of the papermachine clothing, in particular of a dryer fabric, are changed in order to bring about a rapid correction of properties of the clothing in specific regions of the same. The time from the start of the use of the method according to the invention until the final machine stoppage can then also be used for the purpose of discovering the actual reason for the change in properties of the clothing.

The processing of the papermachine clothing is advantageously carried out in a restricted manner from the point of view of location and time. As previously mentioned, the method according to the invention is primarily suitable for local and temporary use. The processing of the clothing, which is specific to this extent, can be carried out immediately after a change in the properties of the clothing has manifested itself.

According to a particularly preferred embodiment of the invention, the processing of the papermachine clothing in order to influence the moisture profile of the papermachine clothing in the transverse direction of the clothing is carried out in that (a) the tension is changed, at least in part of the papermachine clothing; and/or (b) at least part of the papermachine clothing, preferably its surface, is cleaned; and/or (c) a layer with a low fluid permeability is applied to at least part of the papermachine clothing, preferably to part of its surface; and/or (d) the temperature is changed, at least in part of the papermachine clothing. In this connection, it is possible, for example, that the papermachine clothing is/can be produced from a conductive, preferably heat-conducting, material. The use of one or more of the aforementioned method steps normally depends on whether the moisture profile exhibits what are known as peaks downward, that is to say for example toward an increased dryness, or upward, that is to say for example toward an increased moisture.

Changing the tension of the papermachine clothing in the aforementioned step (a) is advantageously carried out by a pressure roll, in such a way that the running length of at least part of the clothing is influenced thereby. The pressure roll can be used for increasing the tension of part of the fabric, which results in an increase in the pressure of the clothing on a specific strip in the machine running direction. It is clear that the papermachine clothing, if this is formed as a dryer fabric, runs over what are known as drying cylinders. The contact region or the contact area between fabric and drying cylinder in this strip is increased as a result, which means that a better drying efficiency and a corresponding correction of the moisture profile results. As a result of the last-named improved drying efficiency, peaks upward in the moisture profile, that is to say what are known as regions of increased moisture, can be eliminated. By the last-named method step, the running distance of the fabric between a plurality of rolls can also be influenced, in particular increased, by the pressure roll.

Advantageously, in the aforementioned step (b), the cleaning of the papermachine clothing can be carried out by a cleaning device which can be displaced, preferably in the transverse direction of the fabric, in such a way that the papermachine clothing continues to circulate during the cleaning and the cleaning device is kept in a fixed location, at least in the longitudinal direction of the clothing, that is to say in the machine running direction. This method step is advantageously used when the moisture profile of the papermachine clothing exhibits regions of lower moisture. In this case, the papermachine clothing is, for example, cleaned locally in the cross-machine direction with a different cleaning intensity by a fluid, the regions with too low a moisture being cleaned with a higher cleaning intensity than the other regions.

The layer with a low fluid permeability according to step (c) is advantageously a thin, water-soluble, non-permanent sheet or a corresponding film. Such a layer is used for the purpose of reducing the permeability of the clothing in a region in which the moisture profile exhibits increased dryness, that is to say to reduce the permeability of the clothing overall in this region. This step is able to reduce the drying in the aforementioned region and, to this extent, to balance out peaks of the moisture profile downward, that is to say regions of increased dryness. As mentioned, this layer can be water-soluble and non-permanent, so that it dissolves itself after a certain time. The lifetime of the layer is advantageously chosen such that it reaches as far as possible until the next stoppage of the paper machine which is planned in any case.

Advantageously, the papermachine clothing is partly heated or cooled in accordance with step (d). Such clothing is advantageously produced from a conductive, preferably heat-conducting, material. Papermachine clothing is normally produced from very highly insulating materials. The use of clothing made of a conductive material permits the use of a heating or cooling device for changing the temperature of the fabric in the region in which a change in the moisture profile occurs which is to be eliminated. Cooling of the clothing in a region of the same reduces the drying in this region, heating increases the dryness of the relevant region.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic, partial plan view of a papermachine fabric with a moisture profile in the transverse direction of the fabric demonstrated below it;

FIG. 2 shows a schematic, partial plan view of a papermachine fabric with another moisture profile in the transverse direction of the fabric illustrated below it; and

FIG. 3 illustrates a schematic, partial plan view of a papermachine fabric with a cleaning device.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

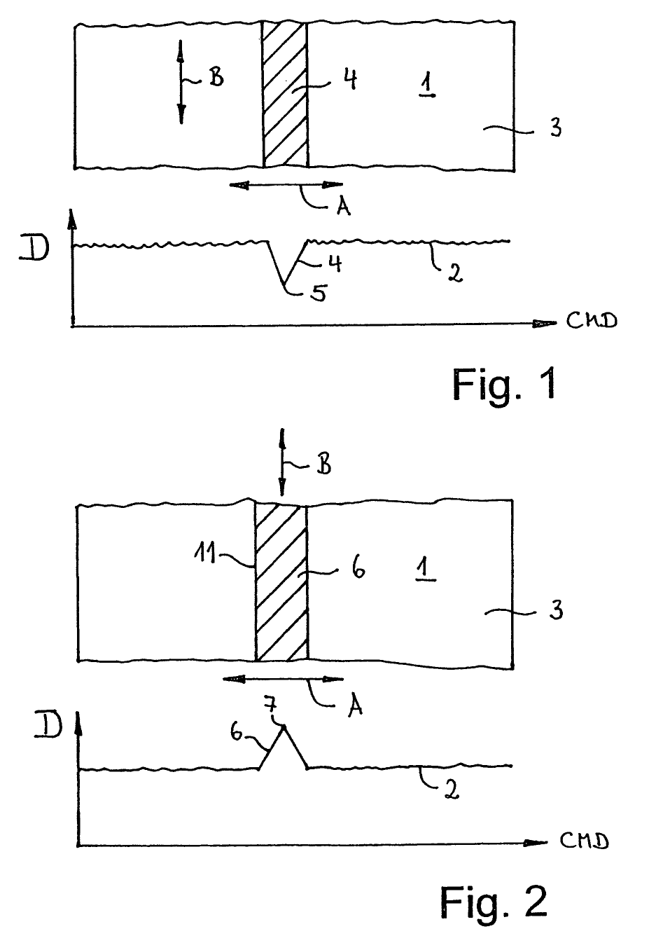

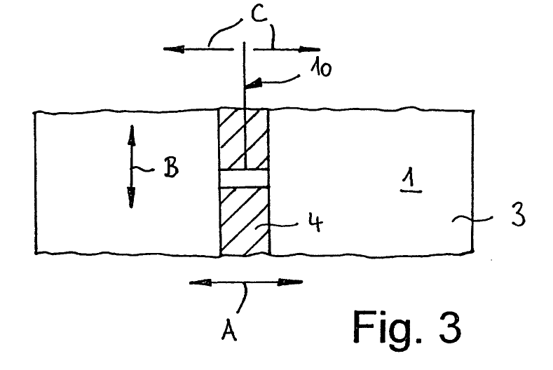

A papermachine fabric 1 normally has a uniform contact area, permeability, temperature and tension when used in a paper machine, not specifically shown. Likewise, the papermachine fabric normally has a uniform moisture profile 2 in the transverse direction of the fabric, according to the double arrow A in FIGS. 1 to 3. To this extent, the directions of the double arrow A correspond to what is known as the cross machine direction. The longitudinal direction of the papermachine fabric 1, which is in particular but not exclusively a dryer fabric, is in each case illustrated by the double arrow B. The directions of the double arrow B therefore illustrate the machine longitudinal direction, also known as the machine direction.

The properties of such a papermachine fabric, called a fabric in short below, can change during the operation of the paper machine and of the fabric, however, and, for example, can lead to problems in the moisture profile 2, that is to say the moisture content, for example on the surface 3 of the fabric 1 in the transverse direction of the fabric (see double arrow A).

Non-uniform and, to this extent, problematic curves of the moisture profile 2 are in each case illustrated in FIGS. 1 and 2 underneath the view of part of the papermachine fabric 1. Here, in each case the dryness D is plotted on the ordinate, the abscissa in each case indicates the transverse direction CMD (cross machine direction) of the fabric. The designation D stands for dryness.

The moisture profile 2 according to FIG. 1 results in a largely uniform moisture content in the edge regions of the fabric but, approximately in the longitudinal center of the fabric, by contrast a region 4 with a considerably reduced dryness, that is to say an increased moisture content. The peak 5 of the moisture profile 2 in FIG. 1 therefore projects downward. The region 4 of reduced dryness is illustrated hatched in the partial plan view of the fabric 1 in FIG. 1.

The relationships in FIG. 2 are the converse. Here, although the moisture profile 2 exhibits a balanced curve in the edge regions of the fabric and an irregularity approximately in the central longitudinal center of the fabric, in this case, the moisture profile 2 exhibits a region 6 of increased dryness approximately in the longitudinal center of the fabric, that is to say a region of reduced moisture content. In this case, the peak 7 of the moisture profile 2 therefore projects upward.

According to the method of the invention for changing properties of the paper machine fabric 1, specifically in particular of a dryer fabric, the papermachine fabric 1 is processed specifically for the purpose of evening out the properties of the fabric, above all in the transverse direction of the fabric (see double arrow A). The processing of the papermachine fabric 1 is normally carried out in a restricted manner in terms of location and time, that is to say only in the region 4 or 6 in which a reduced or increased dryness has been determined.

One of the properties of the papermachine fabric which is to be changed is, for example, the aforementioned moisture profile 2 of the machine fabric in the transverse direction of the fabric. According to the invention, in a particularly preferred embodiment of the invention, the processing of the papermachine fabric in order to influence its moisture profile is carried out in that
(a) the tension is changed, at least in part of the papermachine fabric; and/or
(b) at least part of the papermachine fabric, preferably its surface, is cleaned; and/or
(c) a layer with a low fluid permeability is applied to at least part of the papermachine fabric, preferably to part of its surface; and/or
(d) the temperature is changed, at least in part of the papermachine fabric.

With the aid of individual aforementioned steps or combinations of the same, the properties of the fabric can be changed, so that in particular the moisture profile of the fabric can be corrected therewith.

In step (a), changing the tension of the papermachine fabric is carried out by a pressure roll, not specifically illustrated, in such a way that the contact pressure of the fabric on the cylinder and/or the running length of the fabric can be influenced thereby. According to a particularly preferred embodiment, the cleaning of the papermachine fabric according to step (b) is carried out by a cleaning device 10 which can be displaced, preferably in the transverse direction of the fabric (see double arrow A), in such a way that, during the cleaning, the papermachine fabric 1 continues to circulate in one of the directions of the double arrow B and the cleaning device 10 is kept in a fixed location, at least in the longitudinal direction of the fabric. As previously mentioned, the cleaning device 10 can be displaced in the transverse direction of the fabric (see double arrow A), as indicated by the arrows C. The displacement mechanism, not specifically illustrated, is preferably constructed in such a way that the cleaning device 10 can act on the fabric over the entire width of the latter, if this is desired in the individual case.

Fabrics of this type soil gradually on the paper machine, as a result of which their properties change. The cleaning device can advantageously be programmed in such a way that this cleans the region 4 of the fabric 1 on which problems, for example with respect to the moisture profile, have resulted with a different intensity locally.

According to another embodiment of the invention, the layer 11 with a low fluid permeability according to step (c) is a thin water-soluble, non-permanent sheet or a corresponding film. Such a layer 11 is, for example, placed on a region 6 (see FIG. 2) with increased dryness, in order to reduce the permeability in this region and therefore to contribute to a uniform moisture profile. The dimensions of the layer 11 usually correspond to those of the region 6.

According to another embodiment of the invention, the papermachine fabric is partly heated or cooled in accordance with step (d). The papermachine fabric is in this case preferably produced from a conductive, preferably heat-conducting, material. Another embodiment of the invention could provide for the different temperatures to be set by specifically locally blowing onto the papermachine fabric. With reference to FIG. 2, therefore, the non-hatched edge regions of the fabric 1 could for example have a temperature of 82° C., and the hatched region 6 approximately in the central longitudinal center of the fabric could have a temperature of 60° C. in order to compensate for the moisture profile 2 shown underneath.

The aforementioned method steps (a) to (d) can be applied individually or in combination.

With the method according to the invention, it is possible to change properties of the papermachine fabric locally and temporarily in a specific manner and thus to ensure a constant high quality of the paper produced. The steps of the method according to the invention can be initiated immediately as soon as irregularities in one or more of the properties of the fabric are determined. The method according to the invention can be carried out very economically and permits a stoppage of the fabric and therefore of the paper machine to be delayed, so that ultimately the overall efficiency of the paper machine is improved.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A method for changing properties of papermachine clothing, in particular a dryer fabric, wherein the papermachine clothing is processed specifically, primarily in the transverse direction of the clothing, for the purpose of evening out the properties of the fabric.

2. The method as claimed in claim 1, wherein the processing of the papermachine clothing is carried out in a restricted manner from the point of view of location and time.

3. The method as claimed in claim 1, wherein the processing of the papermachine clothing in order to influence the moisture profile of the papermachine clothing in the transverse direction of the fabric is carried out in that
(a) the tension is changed, at least in part of the papermachine fabric; and/or
(b) at least part of the papermachine fabric, preferably its surface, is cleaned; and/or
(c) a layer with a low fluid permeability is applied to at least part of the papermachine fabric, preferably to part of its surface; and/or
(d) the temperature is changed, at least in part of the papermachine clothing.

4. The method as claimed in claim 3, wherein changing the tension of the papermachine clothing is carried out by a pressure roll, in order that the running length of at least part of the clothing is influenced thereby.

5. The method as claimed in claim 3, wherein the cleaning of the papermachine clothing is carried out by a cleaning device with a different cleaning intensity in the transverse direction of the clothing.

6. The method as claimed in claim 3, wherein the layer with a low fluid permeability is a thin, water-soluble, non-permanent sheet or a corresponding film.

7. The method as claimed in claim 3, wherein the papermachine clothing is at least partly produced from a conductive, preferably heat-conducting, material.
